(19) United States
(12) Patent Application Publication
(10) Pub. No.: US 2008/0068397 A1
(43) Pub. Date: Mar. 20, 2008

(54) Emotion-Based Digital Video Alteration

(76) Inventors: James E. Carey, Rochester, MN (US); Scott N. Gerard, Wake Forest, NC (US)

Correspondence Address: IBM (ROC-BLF), C/O BIGGERS & OHANIAN, LLP, P.O. BOX 1469, AUSTIN, TX, 78767-1469, US

(21) Appl. No.: 11/531,715

(22) Filed: Sep. 14, 2006

(51) Int. Cl. G09G 5/00

(52) U.S. Cl. 345/619

(57) ABSTRACT

Methods, apparatus, and products are disclosed for emotion-based digital video alteration that include receiving digital video of a face of a person, detecting expressions of the face represented in the digital video that characterize an emotional state of the person, and altering expressions of the face represented in the digital video that characterize the emotional state of the person in dependence upon alteration rules. Emotion-based digital video alteration may also include establishing alteration rules by a user. Emotion-based digital video alteration may also include establishing alteration rules by a user displaying the altered expressions of the face represented in the digital video on a display screen.

### BACKGROUND OF THE INVENTION

1. Field of the Invention

The field of the invention is data processing, or, more specifically, methods, apparatus, and products for emotion-based digital video alteration.

2. Description Of Related Art

A person's facial expressions are closely associated with a person's emotional state. For example, a person often smiles when happy, squints their eyes and lowers their brow when in disgust, widens their eyes and opens their mouth when surprised, and so on. One may often, therefore, discern a person's emotion state by observing a person's facial expression.

A person's facial expressions result from one or more motions or positions of the muscles of the face. For example, a genuine smile may be observed when a person contracts the orbicularis oculi muscle to crinkle their eyes and form crow's feet while simultaneously contracting the zygomaticus major muscle to lift up the corners of their mouth. More intense emotional states are accompanied with more pronounced motions or positions of the muscles and, therefore, more prominent corresponding facial expressions.

Often when communicating with other people through digital video, a person may want to reduce or suppress the intensity of their emotional state that is conveyed by their facial expressions. Such a reduction in the intensity of a person's emotional state may be useful in negotiations or other situations in which a person must remain calm. In other situations, a person may desire to enhance or exaggerate the intensity of their emotional state. In such situations, exaggerations may be useful when training people who are deficient in their ability to read emotions or for people who are emotionally reserved.

### SUMMARY OF THE INVENTION

Methods, apparatus, and products are disclosed for emotion-based digital video alteration that include receiving digital video of a face of a person, detecting expressions of the face represented in the digital video that characterize an emotional state of the person, and altering expressions of the face represented in the digital video that characterize the emotional state of the person in dependence upon alteration rules. Emotion-based digital video alteration may also include establishing alteration rules by a user. Emotion-based digital video alteration may also include establishing alteration rules by a user displaying the altered expressions of the face represented in the digital video on a display screen.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a pictorial representation illustrating an exemplary data processing system for emotion-based digital video alteration according to embodiments of the present invention.

FIG. 2 sets forth a block diagram of automated computing machinery comprising an exemplary laptop useful in emotion-based digital video alteration according to embodiments of the present invention.

FIG. 3 sets forth a flow chart illustrating an exemplary method for emotion-based digital video alteration according to embodiments of the present invention.

FIG. 4 sets forth a line drawing illustrating an exemplary table of alteration rules useful in emotion-based digital video alteration according to embodiments of the present invention.

### DETAILED DESCRIPTION OF EXEMPLARY EMBODIMENTS

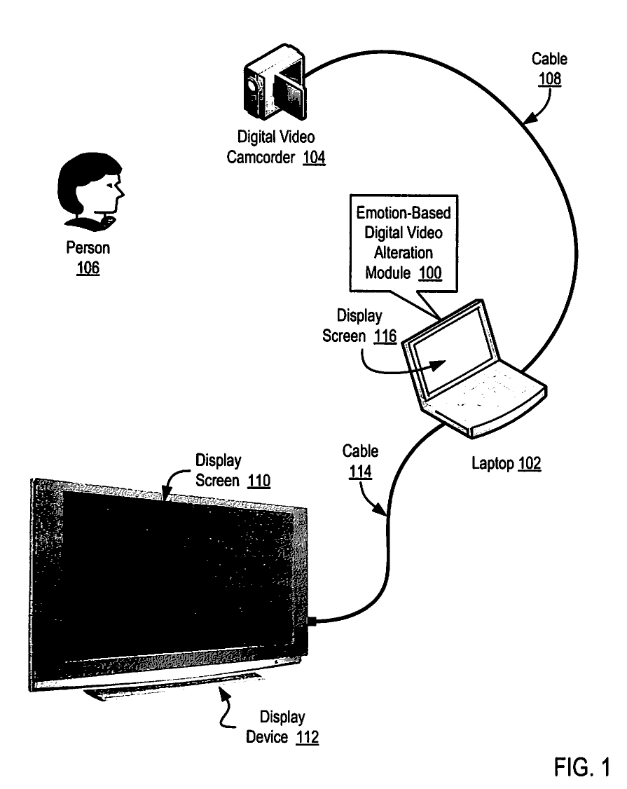

Exemplary methods, apparatus, and products for emotion-based digital video alteration according to embodiments of the present invention are described with reference to the accompanying drawings, beginning with FIG. 1. FIG. 1 sets forth a pictorial representation illustrating an exemplary data processing system for emotion-based digital video alteration according to embodiments of the present invention. The system of FIG. 1 operates generally for emotion-based digital video alteration according to embodiments of the present invention by receiving digital video of a face of a person (106), detecting expressions of the face represented in the digital video that characterize an emotional state of the person (106), and altering expressions of the face represented in the digital video that characterize the emotional state of the person (106) in dependence upon alteration rules.

In the system of FIG. 1, a digital video is a collection of digital frames typically used to create the illusion of a moving picture. Digital video may be used to implement a television show, a movie, a commercial, other content, or data associated with such other content. Each frame of digital video includes image data for rendering one still image and metadata associated with the image data. The metadata of each frame may include synchronization data for synchronizing the frame with an audio stream, configurational data for devices displaying the frame, closed captioning data, and so on.

The system of FIG. 1 includes a laptop (102). The laptop (102) is a general-purpose computer having installed upon it an emotion-based digital video alteration module (100). The emotion-based digital video alteration module (100) of FIG. 1 is a software component that includes computer program instructions for emotion-based digital video alteration according to embodiments of the present invention. The emotion-based digital video alteration module (100) operates generally for emotion-based digital video alteration according to embodiments of the present invention by receiving digital video of a face of a person (106), detecting expressions of the face represented in the digital video that characterize an emotional state of the person (106), and altering expressions of the face represented in the digital video that characterize the emotional state of the person (106) in dependence upon alteration rules.

The laptop (102) of FIG. 1 receives digital video of a face of a person (106) from a digital video camcorder (104) connected to the laptop (102) through a cable (108). The camcorder derives its name from the merger of a camera and recorder into a single electronic device. The digital video camcorder (104) is a portable electronic device for capturing video images and audio and recording video images and audio onto a storage medium. The storage medium may include, for example, flash memory, video tape, or any other storage medium as will occur to those of skill in the art. Although in FIG. 1, the laptop (102) receives digital video from the camcorder (102), readers will note that the laptop (102) may receive digital video from other digital video providers such as for example, a cable television provider, satellite television provider, broadcast television provider, the Internet, or any other provider of digital video as will occur to those of skill in the art. In the example of FIG. 1, the laptop (102) may also receive digital video from removable media such as, for example, a DVD or compact disc playing in the laptop (102) itself.

After altering expressions of the face represented in the digital video, the laptop (102) of FIG. 1 may display the altered expressions of the face represented in the digital video on a display screen (116) of the laptop (102). The laptop (102) of FIG. 1 may also display the altered expressions of the face represented in the digital video on a display screen (110) of a display device (112) connected to the laptop (102) through a cable (114). The cables (114, 112) of FIG. 1 may be implemented as RCA cables, Universal Serial Bus (‘USB’) cables, coaxial cables, Separate Video (‘S-Video’) cables, and so on.

The display device (112) of FIG. 1 is an electronic device that displays each frame of digital video. In the terminology of this specification, displaying a digital video refers to rendering image data of the frame on the display screen along with any metadata of the frame encoded for display such as, for example, closed captioning text. The display device (112) displays the digital video by flashing each frame on the display screen (110) for a brief period of time, typically 1/24th, 1/25th or 1/30th of a second, and then immediately replacing the frame displayed on the display screen with the next frame of the digital video. As a person views the display screen (110), persistence of vision in the human eye blends the displayed frames together to produce the illusion of a moving image.

FIG. 1 depicts the connections between the digital video camcorder (104), the laptop (102), and the display device (112) as direct wireline connections. Readers will note that such a depiction is for explanation and not for limitation. In fact, the connections between the digital video camcorder (104), the laptop (102), and the display device (112) may be implemented as wireless connections implemented, for example, according to the IEEE 802.11 or Bluetooth® family of specifications. The digital video camcorder (104), the laptop (102), and the display device (112) may also be connected together for data communications through a network that supports a variety of data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art.

Readers will further note that the arrangement of devices making up the exemplary system illustrated in FIG. 1 is for explanation, not for limitation. Data processing systems useful according to various embodiments of the present invention may include additional video recording devices, display devices, servers, routers, other devices, network architectures, and peer-to-peer architectures, not shown in FIG. 1, as will occur to those of skill in the art. Moreover, various embodiments of the present invention may be implemented on a variety of hardware platforms in addition to those illustrated in FIG. 1.

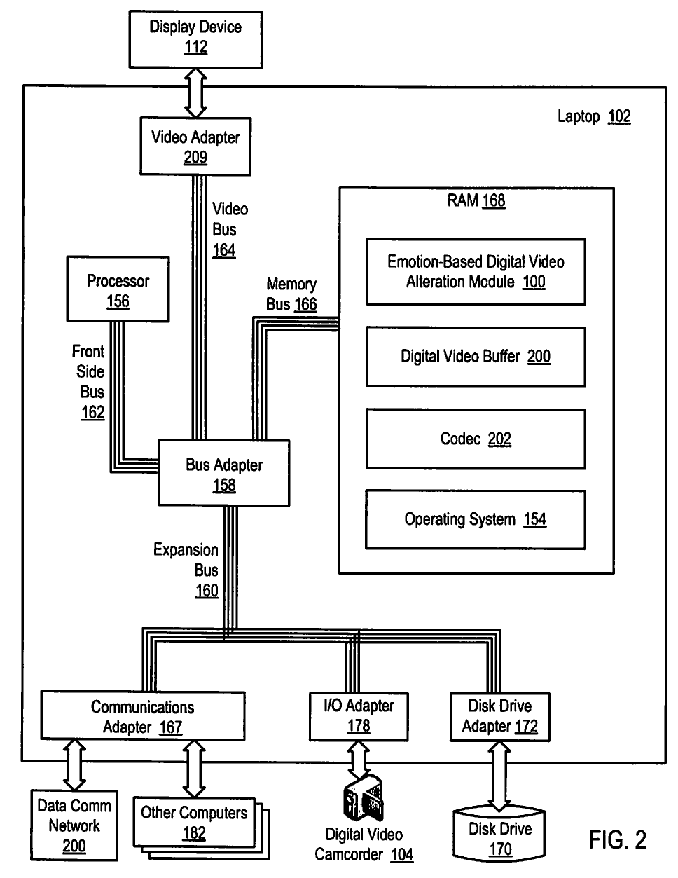

Emotion-based digital video alteration in accordance with the present invention is generally implemented with computers, that is, with automated computing machinery. In the system of FIG. 1, for example, the digital video recorder, the display device, and the laptop are implemented to some extent at least as computers. For further explanation, therefore, FIG. 2 sets forth a block diagram of automated computing machinery comprising an exemplary laptop (102) useful in emotion-based digital video alteration according to embodiments of the present invention. The laptop (102) of FIG. 2 includes at least one computer processor (156) or ‘CPU’ as well as random access memory (168) (‘RAM’) which is connected through a high speed memory bus (166) and bus adapter (158) to processor (156) and to other components of the laptop.

Stored in RAM (168) is an emotion-based digital video alteration module (100). The emotion-based digital video alteration module (100) of FIG. 2 is a software component that includes computer program instructions for emotion-based digital video alteration according to embodiments of the present invention. The emotion-based digital video alteration module (100) of FIG. 2 operates generally for emotion-based digital video alteration according to embodiments of the present invention by receiving digital video of a face of a person, detecting expressions of the face represented in the digital video that characterize an emotional state of the person, and altering expressions of the face represented in the digital video that characterize the emotional state of the person in dependence upon alteration rules.

Also stored in RAM (168) is a digital video buffer (200). The digital video buffer (200) is computer memory used to implement a first-in-first-out (‘FIFO’) buffer. The digital video buffer (200) stores frames of a digital video useful in emotion-based digital video alteration according to embodiments of the present invention. The exemplary laptop (102) performs data processing on the digital video stored in the digital video buffer (200) of FIG. 2 according to the computer program instructions of the emotion-based digital video alteration module (100).

Also stored in RAM (168) is a codec (202). ‘Codec’ is an industry-standard term referring to ‘encoder/decoder.’ The codec (202) of FIG. 2 is a software component capable of performing encoding and decoding on digital video. The codec (202) of FIG. 2 is useful for encoding digital video for transmission, storage or encryption and decoding the digital video for displaying or editing. Although the codec illustrated in FIG. 2 is implemented as a software component, such an implementation is for explanation and not for limitation. In fact, a codec may also be implemented as computer hardware. Examples of codecs useful for emotion-based digital video alteration according to embodiments of the present invention may include Cinepak, Motion JPEG, MPEG, and any other codecs as will occur to those of skill in the art.

Also stored in RAM (168) is an operating system (154). Operating systems useful in laptops according to embodiments of the present invention include UNIX™, Linux™, Microsoft NT™, IBM's AIX™, IBM's i5/OS™, and others as will occur to those of skill in the art. The operating system (154), the emotion-based digital video alteration module (100), the digital video buffer (200), and the codec (202) in the example of FIG. 2 are shown in RAM (168), but many components of such software typically are stored in non-volatile memory also, for example, on a disk drive (170).

The exemplary laptop (102) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in laptops useful according to embodiments of the present invention include the Intel Northbridge, the Intel Memory Controller Hub, the Intel Southbridge, and the Intel I/O Controller Hub. Examples of expansion buses useful in laptops useful according to embodiments of the present invention may include Peripheral Component Interconnect (‘PCI’) buses and PCI Express (‘PCIe’) buses.

The exemplary laptop (102) of FIG. 2 also includes disk drive adapter (172) coupled through expansion bus (160) and bus adapter (158) to processor (156) and other components of the exemplary laptop (102). Disk drive adapter (172) connects non-volatile data storage to the exemplary laptop (102) in the form of disk drive (170). Disk drive adapters useful in laptops include Integrated Drive Electronics (‘IDE’) adapters, Small Computer System Interface (‘SCSI’) adapters, and others as will occur to those of skill in the art. In addition, non-volatile computer memory may be implemented for a laptop as an optical disk drive, electrically erasable programmable read-only memory (so-called ‘EEPROM’ or ‘Flash’ memory), RAM drives, and so on, as will occur to those of skill in the art.

The exemplary laptop (102) of FIG. 2 includes one or more input/output (‘I/O’) adapters (178). I/O adapters in laptops implement user-oriented input/output through, for example, software drivers and computer hardware for controlling output to display devices such as computer display screens, as well as user input from user input devices such as keyboards, mice, or a digital video camcorder (104). The exemplary laptop (102) of FIG. 2 includes a video adapter (209), which is an example of an I/O adapter specially designed for graphic output to a display device (112) such as a display screen or computer monitor. Video adapter (209) is connected to processor (156) through a high speed video bus (164), bus adapter (158), and the front side bus (162), which is also a high speed bus.

The exemplary laptop (102) of FIG. 2 includes a communications adapter (167) for data communications with other computers (182) and for data communications with a data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for emotion-based digital video alteration according to embodiments of the present invention include modems for wired dial-up communications, IEEE 802.3 Ethernet adapters for wired data communications network communications, and IEEE 802.11b adapters for wireless data communications network communications.

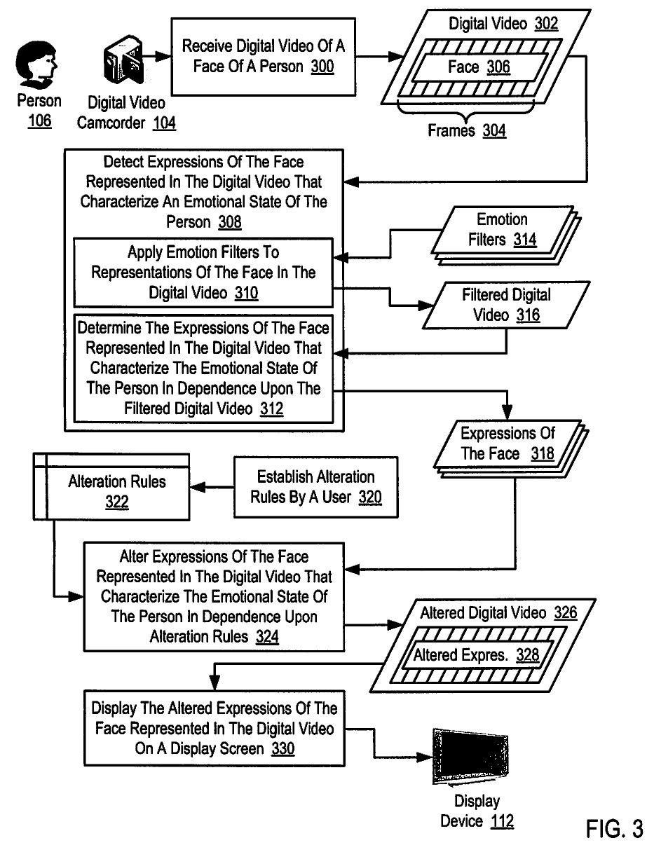

For further explanation, FIG. 3 sets forth a flow chart illustrating an exemplary method for emotion-based digital video alteration according to embodiments of the present invention. The method of FIG. 3 includes receiving (300) digital video (302) of a face (306) of a person (106). The digital video (302) of FIG. 3 represents a collection of digital frames (304) that contain representations of a person's face (306). In the example of FIG. 3, receiving (300) digital video (302) of a face (306) of a person may be carried out by receiving digital video (302) as input from a digital video camcorder (104) and storing the frames (304) of the digital video (302) in a digital video buffer for later alteration.

The method of FIG. 3 also includes detecting (308) expressions (318) of the face represented in the digital video that characterize an emotional state of the person (106). The expressions (318) of the face (306) represented in the digital video (302) are the positions of portions of a person's face (306) represented in the digital video (302) that correspond to an emotional state of the person (106). For example, the expression of lifted corners of a mouth may correspond to happiness, the expression of a crinkled nose may correspond to disgust, and the expression of widened eyes may correspond to surprise. Furthermore, readers will note that expressions (318) of the face (306) may often correspond to more than one emotional state of the person (106). For example, crinkled eyes may correspond to happiness when combined with lifting the corners of the mouth and may correspond to disgust when combined with the lowering of the inner brow.

Detecting (308) expressions (318) of the face represented in the digital video that characterize an emotional state of the person according to the method of FIG. 3 includes applying (310) emotion filters (314) to representations of the face (306) in the digital video (302). Each emotion filter (314) is a filter used to identify an expression of a person's face (306) represented in the digital video (302)—that is, a filter used to identify the position of an isolated portion of a person's face (306) represented in the digital video (302). For example, one emotion filter may be used to identify whether the left eye of a person is crinkled, a second filter may be used to identify whether the right eye of a person is crinkled, a third filter may be used to identify whether the corners of the mouth are lifted up, and so on. Because each emotion filter (314) is associated with identifying a particular expression of a person's face (306), the particular expressions (318) of a persons face may be detected by applying (310) emotion filters (314) to representations of the face (306) in the digital video (302).

In the method of FIG. 3, applying (310) emotion filters (314) to representations of the face (306) in the digital video (302) may be carried out by identifying reference points on an isolated portion of a person's face (306) in each frame of digital video (302), comparing the identified reference points of each frame of the digital video (302) with the corresponding reference points of each emotion filter (314), and storing the difference between the relative locations of the identified reference points of each frame and the corresponding reference points of each emotion filter (314) as filtered digital video (316). The smaller the differences between the relative locations of the identified reference points of each frame and the corresponding reference points of a particular emotion filter (314), the greater the match between the position of a portion of a person's face and the particular emotion filter (314).

Detecting (308) expressions (318) of the face represented in the digital video that characterize an emotional state of the person according to the method of FIG. 3 also includes determining (312) the expressions (318) of the face (306) represented in the digital video (302) that characterize the emotional state of the person in dependence upon the filtered digital video (316). In the method of FIG. 3, determining (312) the expressions (318) of the face (306) represented in the digital video (302) that characterize the emotional state of the person in dependence upon the filtered digital video (316) may be carried out by comparing each frame of the filtered digital video to a filtering threshold to identify which emotion filters (314) match each frame (304) of the digital video (302). The filtering threshold is one or more values used to identify whether the difference between the relative locations of an identified reference point of each frame and a corresponding reference point of a particular emotion filter (314) is small enough to specify that an expression of a person's face matches the particular emotion filter.

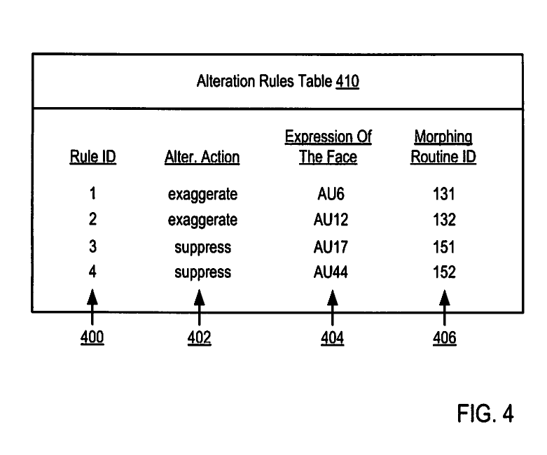

The method of FIG. 3 also includes establishing (320) alteration rules (322) by a user. The alteration rules (322) of FIG. 3 are rules that specify a particular alteration to perform on a particular expression (318) of a person's face when detected according to the embodiments of the present invention. For further explanation, FIG. 4 sets forth a line drawing illustrating an exemplary table (410) of alteration rules useful in emotion-based digital video alteration according to embodiments of the present invention. Each record of the alteration rules table (410) represents an exemplary alteration rule and is identified by an alteration rule identifier (400). Each record includes an alteration action (402), an expression of the face (404), and a morphing routine identifier (406). The alteration action (402) specifies the type of alteration to perform on an expression of the face. The expression of the face (404) specifies the position of a portion of a person's face on which to perform an alteration. The expression of the face (404) specifies when to perform an alteration—that is, when a particular position of a portion of a person's face is detected—and the portion of a person's face on which to perform the alteration. The expressions of the face (404) are specified using the Facial Action Coding System (‘FACS’). The FACS is a system originally developed by Paul Ekman and Wallace Friesen in 1976, to taxonomize most human facial expressions. It defines facial expressions as one of forty-six Action Units (‘AU’), which are contractions or relaxations of one or more muscles in or around a person's face. For example, ‘AU12’ in the FACS represents lifted corners of the mouth. The morphing routine identifier (406) specifies a morphing algorithm capable of performing a particular alteration on a particular expression of a person's face. Such morphing algorithms are well known in the art and include morphing algorithms implemented in computer software such as, for example, Adobe® After Effects®, Avid® Liquid, Sony® Vegas®, and so on.

The alteration rules table (322) of FIG. 4 includes four exemplary alteration rules. The first and second rules specify exaggerating a person's smile that characterizes happiness, while the third and fourth rules specify suppressing a person's facial expressions that characterize disgust. Specifically, the first alteration rule specifies exaggerating the crinkling of a person's eyes using a morphing algorithm identified by a value of ‘131’ for the morphing routine identifier. The second alteration rule specifies exaggerating lifted corners of a person's mouth using a morphing algorithm identified by a value of ‘132’ for the morphing routine identifier. The third alteration rule specifies suppressing the raising of a person's chin using a morphing algorithm identified by a value of ‘151’ for the morphing routine identifier. The fourth alteration rule specifies suppressing the squinting of a person's eyes using a morphing algorithm identified by a value of ‘152’ for the morphing routine identifier.

Turning back to FIG. 3, establishing (320) alteration rules (322) by a user according to the method of FIG. 3 may be carried out by receiving the alteration rules (322) from a user through a user input device such as, for example, a keyboard, mouse, microphone, or a remote control. Readers will note that the user establishing the alteration rules (322) may be the same person whose face is represented in the digital video (302) or a different person. In the method of FIG. 3, establishing (320) alteration rules (322) by a user may further be carried out by storing the alteration rules (322) in a table such as, for example, the exemplary alteration rules table described above with reference to FIG. 4.

The method of FIG. 3 includes altering (324) expressions (318) of the face (306) represented in the digital video (302) that characterize the emotional state of the person in dependence upon alteration rules (322). Altering (324) expressions (318) of the face represented in the digital video (302) that characterize the emotional state of the person in dependence upon alteration rules (322) according to the method of FIG. 3 may include altering expressions of the face represented in the digital video to exaggerate the expressions of the face that characterize the emotional state of the person. Altering (324) expressions (318) of the face represented in the digital video (302) that characterize the emotional state of the person in dependence upon alteration rules (322) according to the method of FIG. 3 may also include altering expressions of the face represented in the digital video to suppress the expressions of the face that characterize the emotional state of the person.

Altering expressions of the face represented in the digital video to exaggerate the expressions of the face that characterize the emotional state of the person may be carried out by identifying, from an alteration rule (322), a morphing algorithm for exaggerating one of the expressions (318) of the face represented in the digital video and executing the identified morphing algorithm on the expression of the person's face represented in the digital video (302). Altering expressions of the face represented in the digital video to exaggerate the expressions of the face that characterize the emotional state of the person may further be carried out by altering the original digital video (302) to include the exaggerated expressions of the face represented in the digital video.

In addition to exaggerating the expressions of the face that characterize the emotional state of the person by morphing those expressions to make the expressions appear more prominent, altering expressions of the face represented in the digital video to exaggerate the expressions of the face that characterize the emotional state of the person may also be carried out by identifying, from an alteration rule (322), expressions of the person's face to exaggerate and lengthening the duration of time those expressions of the face are displayed on a display screen. Lengthening the duration of time those expressions of the face are displayed on a display screen may be carried out by inserting duplicates frames in the digital video (302) of frames that contain representations of an expression (318) of the face specified in the alteration rules (312). In such a manner, expressions of the face that occur very briefly in real-time may be extended to permit easy observation of these ‘micro-expressions.’

The description above describes altering (324) expressions (318) of the face represented in the digital video (302) that characterize the emotional state of the person in dependence upon alteration rules (322) in terms of altering expressions of the face represented in the digital video to exaggerate the expressions of the face that characterize the emotional state of the person. Altering expressions of the face represented in the digital video to suppress the expressions of the face that characterize the emotional state of the person may be carried out in a manner similar to altering expressions of the face represented in the digital video to exaggerate the expressions of the face that characterize the emotional state of the person as discussed above.

In the example of FIG. 3, the altered digital video (326) represents an altered version of the digital video (302) that includes representations of the altered expressions (328) of the face. Readers will note that altering the original digital video (302) to include the altered expressions of the face is for explanation and not for limitation. Altering (324) expressions (318) of the face (306) represented in the digital video (302) that characterize the emotional state of the person in dependence upon alteration rules (322) according to the method of FIG. 3 may also be carried out by storing the altered expressions of the face separately from the original digital video (302).

The method of FIG. 3 includes displaying (330) the altered expressions of the face represented in the digital video on a display screen (112). The display screen (112) may be implemented as a display screen of a computer display, a television display, a projection system, or any other display screen as will occur to those of skill in the art. Displaying (330) the altered expressions of the face represented in the digital video on a display screen (112) according to the method of FIG. 3 may be carried out by displaying the altered digital video (326) that includes altered expressions (328) of the person's face on the display screen (112). Readers will note, however, that displaying the altered digital video (326) that includes altered expressions (328) of the person's face on the display screen (112) is for explanation and not for limitation. In fact, displaying (330) the altered expressions of the face represented in the digital video on a display screen (112) may also be carried out by displaying only the altered expressions of the face represented in the digital video on the display screen (112). In view of the explanations set forth above in this document, readers will recognize that practicing emotion-based digital video alteration according to embodiments of the present invention provides the following benefits:
Users may hide or suppress emotion when communicating with people through digital video,
Users may enhance or exaggerate their emotions when communicating with people through digital video, and
User may easily detect micro-expressions convey by the face of a person.

Exemplary embodiments of the present invention are described largely in the context of a fully functional computer system for emotion-based digital video alteration. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of emotion-based digital video alteration, the method comprising:
receiving digital video of a face of a person;
detecting expressions of the face represented in the digital video that characterize an emotional state of the person; and
altering expressions of the face represented in the digital video that characterize the emotional state of the person in dependence upon alteration rules.

2. The method of claim 1 wherein altering expressions of the face represented in the digital video that characterize the emotional state of the person in dependence upon alteration rules further comprises altering expressions of the face represented in the digital video to exaggerate the expressions of the face that characterize the emotional state of the person.

3. The method of claim 1 wherein altering expressions of the face represented in the digital video that characterize the emotional state of the person in dependence upon alteration rules further comprises altering expressions of the face represented in the digital video to suppress the expressions of the face that characterize the emotional state of the person.

4. The method of claim 1 wherein detecting expressions of the face represented in the digital video that characterize an emotional state of the person further comprises:
applying emotion filters to representations of the face in the digital video; and
determining the expressions of the face represented in the digital video that characterize the emotional state of the person in dependence upon the filtered digital video.

5. The method of claim 1 further comprising establishing alteration rules by a user.

6. The method of claim 1 further comprising displaying the altered expressions of the face represented in the digital video on a display screen.

7. An apparatus for emotion-based digital video alteration, the apparatus comprising a computer processor, a computer memory operatively coupled to the computer processor, the computer memory having disposed within it computer program instructions capable of:
receiving digital video of a face of a person;
detecting expressions of the face represented in the digital video that characterize an emotional state of the person; and
altering expressions of the face represented in the digital video that characterize the emotional state of the person in dependence upon alteration rules.

8. The apparatus of claim 7 wherein altering expressions of the face represented in the digital video that characterize the emotional state of the person in dependence upon alteration rules further comprises altering expressions of the face represented in the digital video to exaggerate the expressions of the face that characterize the emotional state of the person.

9. The apparatus of claim 7 wherein altering expressions of the face represented in the digital video that characterize the emotional state of the person in dependence upon alteration rules further comprises altering expressions of the face represented in the digital video to suppress the expressions of the face that characterize the emotional state of the person.

10. The apparatus of claim 7 wherein detecting expressions of the face represented in the digital video that characterize an emotional state of the person further comprises:
applying emotion filters to representations of the face in the digital video; and
determining the expressions of the face represented in the digital video that characterize the emotional state of the person in dependence upon the filtered digital video.

11. The apparatus of claim 7 further comprising computer program instructions capable of establishing alteration rules by a user.

12. The apparatus of claim 7 further comprising computer program instructions capable of displaying the altered expressions of the face represented in the digital video on a display screen.

13. A computer program product for emotion-based digital video alteration, the computer program product disposed upon a signal bearing medium, the computer program product comprising computer program instructions capable of:
receiving digital video of a face of a person;
detecting expressions of the face represented in the digital video that characterize an emotional state of the person; and
altering expressions of the face represented in the digital video that characterize the emotional state of the person in dependence upon alteration rules.

14. The computer program product of claim 13 wherein the signal bearing medium comprises a recordable medium.

15. The computer program product of claim 13 wherein the signal bearing medium comprises a transmission medium.

16. The computer program product of claim 13 wherein altering expressions of the face represented in the digital video that characterize the emotional state of the person in dependence upon alteration rules further comprises altering expressions of the face represented in the digital video to exaggerate the expressions of the face that characterize the emotional state of the person.

17. The computer program product of claim 13 wherein altering expressions of the face represented in the digital video that characterize the emotional state of the person in dependence upon alteration rules further comprises altering expressions of the face represented in the digital video to suppress the expressions of the face that characterize the emotional state of the person.

18. The computer program product of claim 13 wherein detecting expressions of the face represented in the digital video that characterize an emotional state of the person further comprises:
applying emotion filters to representations of the face in the digital video; and
determining the expressions of the face represented in the digital video that characterize the emotional state of the person in dependence upon the filtered digital video.

19. The computer program product of claim 13 further comprising computer program instructions capable of establishing alteration rules by a user.

20. The computer program product of claim 13 further comprising computer program instructions capable of displaying the altered expressions of the face represented in the digital video on a display screen.
